(19) United States
(12) Patent Application Publication
(10) Pub. No.: US 2022/0230611 A1
(43) Pub. Date: Jul. 21, 2022

(54) DEVICE FOR GUITAR

(71) Applicants: Daniel Joseph Larocque, Manchester, NH (US); Jon Cabral, Portland, OR (US)

(72) Inventors: Daniel Joseph Larocque, Manchester, NH (US); Jon Cabral, Portland, OR (US)

(21) Appl. No.: 17/713,752

(22) Filed: Apr. 5, 2022

Related U.S. Application Data
(60) Provisional application No. 63/227,123, filed on Jul. 29, 2021.

(51) Int. Cl. G10H 3/18; G10H 1/00; G10D 3/00; G10H 1/34

(52) U.S. Cl. CPC G10H 3/186; G10H 1/0083; G10H 2220/461; G10H 1/34; G10D 3/00

(57) ABSTRACT

A hand-operated device for use with a guitar to operate an external or internal sound signal processing device, wherein the hand-operated device can be actuated by a hand used in the strumming of the guitar. The device can be mounted to the body of the guitar and in proximity to the strings of the guitar. The device includes a switch or lever that can be actuated by the guitarists and the actuation of the switch results in a signal to operate the external or internal sound signal processing device, wherein the signal is sent by a transmitter also disposed within a housing of the device.

### CROSS-REFERENCE TO RELATED APPLICATIONS

This application claims priority to the U.S. provisional patent application Ser. No. 63/227,123, filed on Jul. 29, 2021, which is incorporated herein by reference in its entirety.

### FIELD OF INVENTION

The present invention relates to a device for a string instrument, and more particularly, the present invention relates to a hand-operated device for a string instrument to operate an external or internal electronic device during playing the guitar.

### BACKGROUND

Audio signal processing devices are electronic devices known for manipulating the sound output from musical instruments and other audio sources. The audio signal processing devices are commonly used by musicians, music producers, audio engineers, and the like to modify the sound output. A range of sound effects can be generated by using audio signal processing devices.

For certain musical instruments that are played by hand, such as an electric guitar, bass guitar, electronic keyboard, and electric piano, the output of the musical instrument is connected to a sound signal processing device which is operated by a foot of the player to add special effects to the sound output from the musical instrument taking the music to next level.

An effects pedal, also known as an effects unit, is a type of sound signal processing device used with electric guitars, bass guitars, and acoustic guitars for a range of sound effects such as distortion/overdrive. The effects pedal has foot switches/pedals that can be actuated by the foot of the guitarist while playing the guitar. The effects pedal can be placed on a floor and the guitarist can press the footswitches/pedals with the foot while playing the guitar. The effects pedals are used by the musicians in studios, live performances, as well as casually for recreation purposes.

Although the use of effects pedals with guitars and similar electronic musical instruments provides a horizon of possibilities to manipulate the sound output for an overall sound experience, the use of effects pedal requires coordination between the hand and the foot, which is difficult to learn by many. This is a major limitation to the adoption of effects pedal by many of the guitarists. Thus, a need is appreciated for a device that overcomes the aforesaid limitation while having all the advantages of the effects pedal.

The strumming motion hereinafter refers to different actions of picking, plucking, and sweeping the thumb and/or a finger up and down on the strings of a stringed musical instrument.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a hand-operated device for a string instrument that can be used to operate an audio signal processing device while playing the string instrument.

It is another object of the present invention that the hand-operated device can be temporarily or permanently mounted to the musical instrument.

Is still another object of the present invention that the audio signal processing device can be operated by a strumming motion with a hand.

In one aspect, disclosed is a method for operating an electronic device using a first hand during the playing of a musical instrument, the method comprising the steps of providing a device, the device comprising a housing configured to mount the device to a body of the musical instrument, an actuator protrudes from the housing and is configured to be actuated by a first hand during the playing of the musical instrument by the first hand, wherein the actuator is configured to generate a signal when actuated, and a transmitter configured to send the signal to the electronic device; playing the musical instrument by the first hand; and during playing, actuating the actuator by the first hand. The musical instrument is a guitar, wherein the device is mounted in proximity to the strings of the guitar. The device is mounted to a neck of the guitar. Or the device is mounted to a soundbox of the guitar or nearby the soundbox of the guitar. The actuator is actuated by strumming motion using a pick of the guitar by the first hand. The actuator is actuated by pushing down a switch of the actuator using a pick of the guitar by the first hand. The electronic device is a sound signal processing device.

In one aspect, disclosed is a device for operating an electronic device during the playing of a musical instrument, the device comprising a housing configured to be mounted to a body of the musical instrument; an actuator that protrudes from the housing and is configured to be actuated by the first hand during the playing of the musical instrument by the first hand, wherein the actuator is configured to generate a signal when actuated; and a transmitter configured to send the signal to the electronic device. The musical instrument is a guitar, wherein the housing is configured to be mounted in proximity to the strings of the guitar. The actuator comprises a lever, wherein the lever is configured to be actuated by strumming motion using a pick of the guitar by the first hand. The actuator comprises a switch, wherein the switch is configured to be actuated by pushing down the switch using a pick of the guitar by the first hand. The electronic device is a sound signal processing device, and the transmitter is a wireless transmitter. The housing comprises a clamp configured to mount to a neck or a body of the guitar.

In one aspect, disclosed is a guitar comprising a device for operating an electronic device during the playing of guitar, the device comprising a housing mounted to a body of the guitar and in proximity to strings of the guitar; an actuator that protrudes from the housing and is configured to be actuated by the first hand during the playing of the guitar by the first hand, wherein the actuator is configured to generate a signal when actuated; and a transmitter configured to send the signal to the electronic device. The actuator comprises a lever, wherein the lever is configured to be actuated by strumming motion using a pick of the guitar by the first hand. The actuator comprises a switch, wherein the switch is configured to be actuated by pushing down the switch using a pick of the guitar by the first hand. The electronic device is a sound signal processing device, and the transmitter is a wireless transmitter. The housing comprises a clamp configured to mount to a neck or a body of the guitar.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a perspective view of the disclosed device showing different components, according to an exemplary embodiment of the present invention.

FIG. 2 shows the device mounted to a neck of a guitar, according to an exemplary embodiment of the present invention.

FIG. 3 shows the device mounted to a soundhole of the guitar, according to an exemplary embodiment of the present invention.

FIG. 4 is a side view of the device shown in FIG. 3, according to an exemplary embodiment of the present invention.

FIG. 5A is a perspective view of a clip of the device, according to an exemplary embodiment of the present invention.

FIG. 5B is a side view of the clip, according to an exemplary embodiment of the present invention.

FIG. 6 shows the device mounted to the body of the guitar near the strings and the soundhole, further showing the actuation of the device by a pick, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, the reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an”, and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention since the scope of the invention will be best defined by the allowed claims of any resulting patent.

Disclosed is a hand-operated device for use with musical instruments, such as guitars that allow operating an external or internal electronic device by a player with hand during the playing of the musical instrument with the hand. The guitar can be an electric guitar, bass guitar, or acoustic guitar. While certain embodiments have been described using the guitar as the musical instrument, however, it is understood that any musical instrument that can be played by hand and an output of which can be processed by an audio signal processing device, is within the scope of the present invention. The electronic device can be a sound signal processing device. The external electronic device can be separate from the guitar and provided at a distance from the guitar. Alternatively, the electronic device can be internal and mounted within the body of the guitar. The electronic device, in certain exemplary embodiments, can process the sound signal output from the musical instrument for special effects. Such techniques of sound signal processing and adding special effects are well known, and any such electronic device is within the scope of the present invention. The structure and functioning of the electronic devices for manipulating sound signals are also well known to a skilled person. Also, it is understood that more than one electronic device can be simultaneously used with the disclosed device without departing from the scope of the present invention. Also, the different electronic devices can be interchangeably used with the disclosed device without departing from the scope of the present invention. The use of different electronic devices for different special effects is also well known. It is, however, understood that the electronic device may perform a function other than sound signal processing, and any such electronic device can be used with the disclosed device without departing from the scope of the present invention.

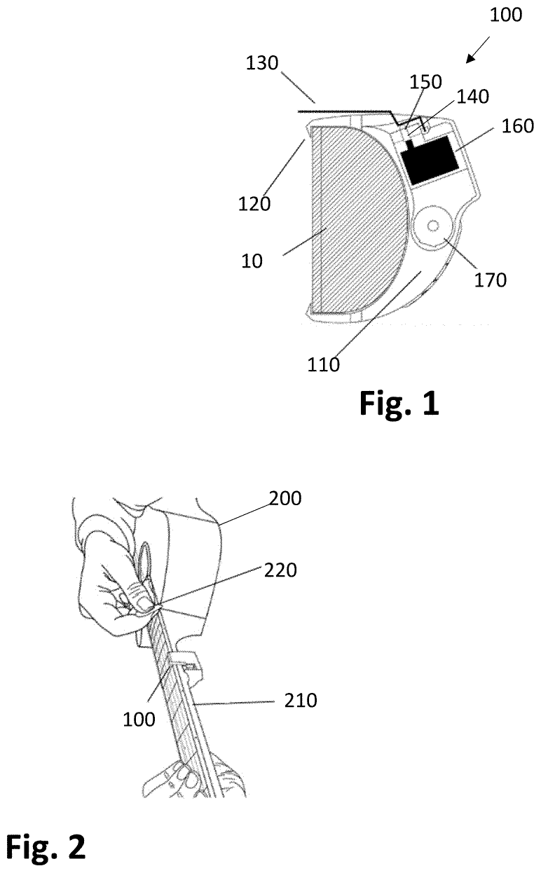

Referring to FIG. 1 which shows an exemplary embodiment of the present invention, the disclosed device 100 can include a housing 110. The housing can be mounted to a body of a guitar, such as to the neck of the guitar. The housing can include suitable clamps 120 to mount the disclosed device to the body of the guitar. The clamps can be interchangeable to allow the housing to mount to the neck of different shapes and sizes, and other parts of the body of the guitar. FIG. 1 shows the clamp 120 clamped to a neck 10 of the guitar. Besides the clamps, suitable fasteners can also be used, the fasteners include adhesives.

The device 100 can include a lever 130 protruding from the housing 110 upwards and away from the housing. When the housing is mounted to the neck of the guitar, the lever can protrude upwards, passing by the neck and towards the front side of the guitar. The front side of the guitar has frets and strings. The lever can in proximity to the strings, such as to be within the reach of a hand of a guitarist. The guitarist can actuate the lever during playing the guitar. The lever can be actuated by a strumming motion with the hand during playing the guitar, the hand used to strum the strings.

The actuating of the lever 130 may result in flexing of the lever, which is a mechanical action or motion. The device can further include a processing unit 140 enclosed within the housing 110 and operably coupled to the lever 130. The processing unit 140 can convert the mechanical action of the lever into digital signals. For example, a pressure-sensitive switch 150 can be provided encased within the housing. The flexing of the lever can result in the actuation of the pressure-sensitive switch which in turn can process the applied pressure to the digital signals. The pressure-sensitive switch and the processing unit can be a single unit or separate, wherein the processing unit can convert the mechanical signal to digital signals for transmission to the electronic device. It is understood to a reader of this disclosure that the pressure-sensitive switch can be replaced by any other switch that can detect motion or flexion of the lever. The switch and the processing unit can convert the mechanical motion/flexion of the lever to a digital signal. In one case, the switch can convert the motion signal to an electrical signal and the processing unit can convert the electrical signals to digital signals.

The device can further include a transmitting unit 160 for transmitting the digital signals to the external or internal electronic device. The transmitting unit can be a Wi-Fi transmitter, a Bluetooth™ transmitter, and the like. The structure, functioning, and technology behind the transmitters are well known and any such technology is within the scope of the present invention. The electronic devices that may be commercially available may not have receivers to receive the digital signals from the transmitter and operate the electronic device based on the digital signals. The disclosed device can further include such receivers that can be coupled to an existing electronic device for receiving the digital signals from the transmitter and operating the electronic device based on the digital signals. Also is disclosed an electronic device with the receiver, wherein the electronic device can perform one or more functions, such as sound signal processing.

The different components including the processing unit and the transmitter can be powered by a battery 170 also enclosed within the housing. The battery can be a rechargeable battery, such as a lithium-ion battery. Alternatively, the battery can be a disposable battery that can be replaced with a new battery. The rechargeable battery can also be replaced with a charged battery, and the exhausted battery can be charged by an external charger. Alternatively, a charging circuitry can also be provided enclosed within the housing that allows charging the rechargeable battery from an external power supply. Direct powering of the disclosed device by an external power supply is also within the scope of the present invention. Moreover, the external power supply can be wired or wireless, and both are within the scope of the present invention.

Referring to FIG. 2 which shows the disclosed device 100 mounted to a bottom of a neck 210 of a guitar 200. The lever can also be seen protruding upwards from the hosing and passing by the neck of the guitar. FIG. 2 also shows the playing of the guitar by the guitarist using a pick and the lever is shown within reach of the hand 220.

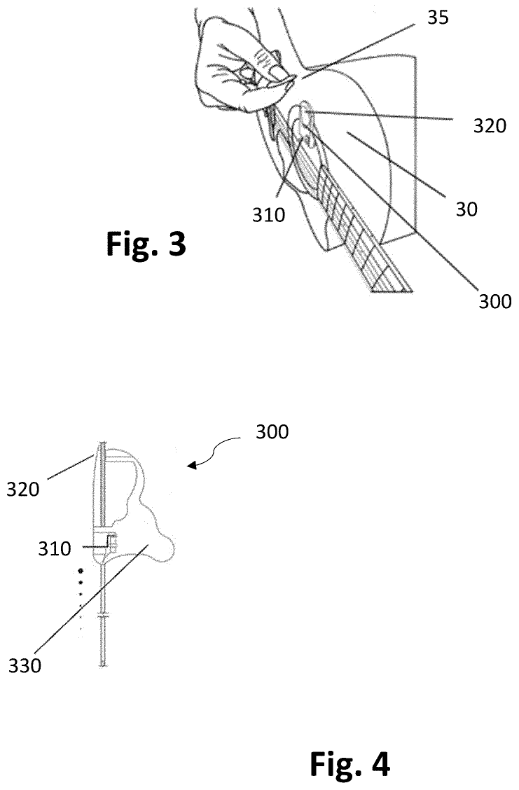

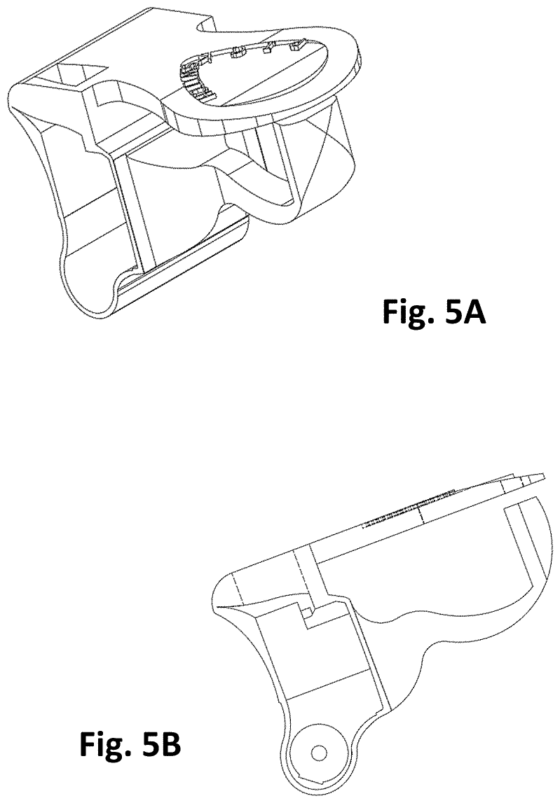

Referring to FIG. 3 which shows an alternate position of the disclosed device 300 on a guitar 30. The device 300 is positioned within a soundbox of the body 35 of the guitar 30. The lever 310 can protrude above the body of the guitar from the soundbox. The clamp 320 can also be seen that is adapted to mount the device 300 to the body of the guitar. A side view of device 300 is also shown in FIG. 4 which includes housing 330, the clamp 320, and the switch 310. An exemplary embodiment of the housing and the clamp is also shown in FIGS. 5A and 5B.

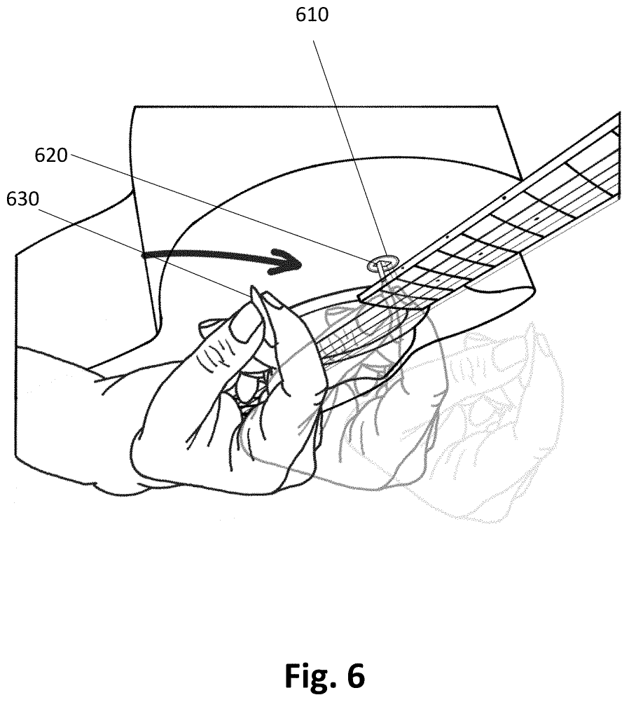

Referring to FIG. 6 which shows an alternate embodiment of the disclosed device that can be mounted within the hollow body of the guitar. An aperture 610 can be made in the front face of the body of the guitar and a switch 620 can protrude from the aperture 610. The switch can be pushed by the pick 630 as shown in the drawings while playing the guitar. The switch 620 is in proximity to the strings of the guitar.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for operating an electronic device by a first hand during playing of a musical instrument, the method comprising the steps of:
providing a device, the device comprising:
a housing configured to mount the device to a body of the musical instrument,
an actuator protrudes from the housing and is configured to be actuated by a first hand during the playing of the musical instrument by the first hand, wherein the actuator is configured to generate a signal when actuated, and
a transmitter configured to send the signal to the electronic device;
playing the musical instrument by the first hand; and
during playing, actuating the actuator by the first hand.

2. The method according to claim 1, wherein the musical instrument is a guitar, wherein the device is mounted in proximity to strings of the guitar.

3. The method according to claim 2, wherein the device is mounted to a neck of the guitar.

4. The method according to claim 2, wherein the device is mounted to a soundbox of the guitar or nearby the soundbox of the guitar.

5. The method according to claim 2, wherein the actuator is actuated by strumming motion using a pick of the guitar by the first hand.

6. The method according to claim 2, wherein the actuator is actuated by pushing down a switch of the actuator using a pick of the guitar by the first hand.

7. The method according to claim 2, wherein the electronic device is a sound signal processing device.

8. A device for operating an electronic device during playing of a musical instrument, the device comprising:
a housing configured to be mounted to a body of the musical instrument;
an actuator that protrudes from the housing and is configured to be actuated by a first hand during the playing of the musical instrument by the first hand, wherein the actuator is configured to generate a signal when actuated; and
a transmitter configured to send the signal to the electronic device.

9. The device according to claim 8, wherein the musical instrument is a guitar, wherein the housing is configured to be mounted in proximity to strings of the guitar.

10. The device according to claim 9, wherein the actuator comprises a lever, wherein the lever is configured to be actuated by strumming motion using a pick of the guitar by the first hand.

11. The device according to claim 9, wherein the actuator comprises a switch, wherein the switch is configured to be actuated by pushing down the switch using a pick of the guitar by the first hand.

12. The device according to claim 9, wherein the electronic device is a sound signal processing device, and the transmitter is a wireless transmitter.

13. The device according to claim 9, wherein the housing comprises a clamp configured to mount to a neck or a body of the guitar.

14. A guitar comprising:
a device for operating an electronic device during playing of guitar, the device comprising:
a housing mounted to a body of the guitar and in proximity to strings of the guitar;
an actuator that protrudes from the housing and is configured to be actuated by a first hand during the playing of the guitar by the first hand, wherein the actuator is configured to generate a signal when actuated; and
a transmitter configured to send the signal to the electronic device.

15. The guitar according to claim 14, wherein the actuator comprises a lever, wherein the lever is configured to be actuated by strumming motion using a pick of the guitar by the first hand.

16. The guitar according to claim 14, wherein the actuator comprises a switch, wherein the switch is configured to be actuated by pushing down the switch using a pick of the guitar by the first hand.

17. The guitar according to claim 14, wherein the electronic device is a sound signal processing device, and the transmitter is a wireless transmitter.

18. The guitar according to claim 14, wherein the housing comprises a clamp configured to mount to a neck or a body of the guitar.
